(19) United States
(12) Patent Application Publication
(10) Pub. No.: US 2007/0062445 A1
(43) Pub. Date: Mar. 22, 2007

(54) Coating method and equipment, process for producing optical film, and process for producing antireflection film

(75) Inventors: Atsushi Kodou, Fujinomiya-shi (JP); Youichi Hasegawa, Fujinomiya-shi (JP); Kazuhiko Nojo, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/520,632

(22) Filed: Sep. 14, 2006

(30) Foreign Application Priority Data
Sep. 16, 2005 (JP) 2005-270863

(51) Int. Cl. B05D 3/12; B05C 5/00; B05B 1/14

(52) U.S. Cl. 118/325; 427/355; 239/568; 118/300

(57) ABSTRACT

A method for coating, comprising the step of: coating with a coating solution using a slot die the surface of a substrate which is continuously running while being supported by a back-up roller, wherein the slot width d of the slot die is 250 μm or less and the ratio of the slot length L to the slot width d, L/d, is 300 or more.

### BACKGROUND OF THE INVENTION

1. Field of the Invention

The present invention relates to a coating method, coating equipment, a process for producing an optical film and a process for producing an antireflection film, in particular, a coating method, coating equipment, a process for producing an optical film and a process for producing an antireflection film which are suitably used for forming a high-quality coating layer on a flexible substrate, which is continuously running while being supported by a guiding device, such as a guide roller.

2. Description of the Related Art

As coating equipment which applies a coating film (coating layer) of desired thickness to the surface of a flexible substrate strip (hereinafter referred to as web), coaters (coating equipment) such as bar, reverse roll, gravure roll and extrusion coaters are known. Of these coaters, slot die coaters are often used, compared with coaters of other systems, because they are capable of applying a thin film at high speeds.

In slot die coaters, represented by extrusion coaters, a coating solution is applied to a web by forming a bead of coating solution between the web and the slot die. To uniformly apply a coating solution to a web so as to prevent the occurrence of poor coating, such as so-called step unevenness, in the resultant coating film, it is important to control fluctuations in the amount of the coating solution applied. In other words, fluctuations in the amount of the coating solution applied cause surface defects, such as step unevenness, in the coating film formed on the web. Particularly when the amount of the coating solution applied is so small that the resultant coating film has a wet film thickness of 15 μm or less, the capability of keeping the coating solution in the form of a bead is decreased, and fluctuations in the amount of the coating solution applied are more likely to cause surface defects, such as step unevenness, of the resultant coating film.

Under those circumstances, there is disclosed, in Japanese Patent Application Laid-Open No. 2003-10762, an extrusion coater in which the slot width (slot clearance) and slot length are specified depending on the pressure loss in the pocket to cope with the fluctuations, across the width of a web, in the amount of the coating solution applied.

There is also disclosed, in Japanese Patent Application Laid-Open No. 5-104053, an extrusion coater in which the slot width (slot clearance) is specified by inserting a member which narrows the slot clearance in the inside of the slot to cope with the fluctuations, across the width of a web, in the amount of the coating solution applied.

However, the foregoing prior art still presents some unsolved problems.

Specifically, the extrusion coater disclosed in Japanese Patent Application Laid-Open No. 2003-10762 presents problems such that, though the slot clearance and slot length are specified, the effect is not supposed when the amount of coating is small, and moreover, the effect is insufficient for a kind of merchandise, such as optical functional films, where high-precision coating is required.

The extrusion coater described in Japanese Patent Application Laid-Open No. 5-104053 also presents problems such that high precision is required in forming the member, and therefore, the clearance in the inside of the slot is hard to narrow with high precision, and moreover, the effect of controlling the pulsation of coating solution and the fluctuation in the amount of coating is insufficient.

The present invention has been made in the light of the above described problems. Accordingly, a primary object of the present invention is to provide a coating method, coating equipment, a process for producing an optical film and a process for an antireflection film all of which can retard the occurrence of step unevenness of coating film attributed to vibration of building (floor) etc. or pulsation of coating solution during its feeding, thereby forming a high-quality coating layer.

### SUMMARY OF THE INVENTION

To achieve the above described object, the present invention provides a method for coating with a coating solution using a slot die the surface of a substrate which is continuously running while being supported by a back-up roller, wherein the slot width d of the slot die is 250 μm or less and the ratio of the slot length L to the slot width d, L/d, is 300 or more.

To achieve the above described object, the present invention provides equipment for coating with a coating solution using a slot die the surface of a substrate which is continuously running while being supported by a back-up roller, wherein the slot width d of the slot die is 250 μm or less and the ratio of the slot length L to the slot width d, L/d, is 300 or more.

According to the present invention, the slot width d of the slot die is 250 μm or less and the ratio of the slot length L to the slot width d, L/d, is 300 or more, whereby the pulsation of the coating solution during its feeding can be effectively retarded, and hence the occurrence of step unevenness also can be retarded. The details of the structure of the slot die and those of the relationship between the pulsation of coating solution during its feeding and step unevenness will be described later.

In the present invention, preferably the viscosity of the coating solution applied is 15×10⁻³ Pa·s or less. Also preferably, the film of the coating solution is formed so that the wet film thickness is 15 μm or less. The present invention produces larger effect when it is used for applying a low viscosity coating solution to form a thin layer.

As described so far, according to the present invention, the pulsation of a coating solution during its feeding can be effectively retarded, and hence the occurrence of step unevenness also can be retarded.

### BRIEF DESCRIPTION OF THE DRAWINGS

FIG. 1 is a block diagram illustrating the entire construction of the optical film production line to which the coating method, coating equipment, process for producing an optical film and process for producing antireflection film of the present invention are applied;

FIG. 2 is a perspective view, partially cut away, showing part of the coating head of extrusion coating equipment;

FIG. 3 is a schematic cross-sectional view showing the positional relation between the leading edge of the coating head in FIG. 2 and a web;

FIG. 4 is a perspective view showing the coating head and its vicinities;

FIG. 5 is a schematic cross-sectional view showing the layer construction of a sheet polarizer;

FIG. 6 is a table showing the degree of vacuum of the vacuum chamber;

FIG. 7 is a graph showing the measurements of the pressure fluctuations in the inside of the fluid reservoir of the coating head;

FIG. 8 is a schematic view showing the evaluation levels of step unevenness failures;

FIG. 9 is a graph showing the change in film thickness occurring in a failure;

FIG. 10 is a table showing the results of Example 1; and

FIG. 11 is a table showing the results of Example 2.

### DETAILED DESCRIPTION OF THE PREFERRED EMBODIMENTS

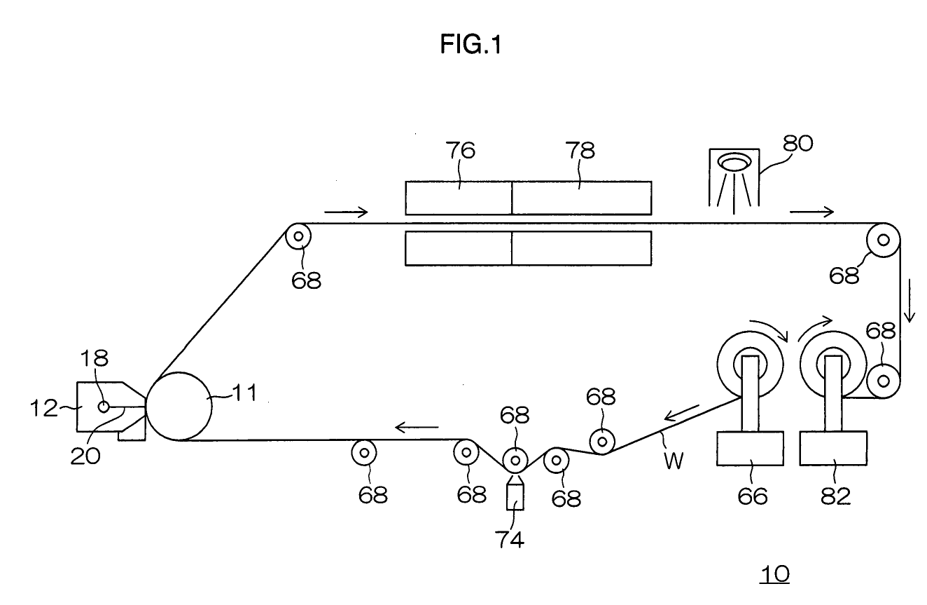

In the following the embodiment of the present invention will be described with reference to the accompanying drawings. FIG. 1 is a block diagram illustrating the entire construction of the optical film production line 10 to which the coating method, coating equipment, process for producing an optical film and process for producing antireflection film of the present invention are applied.

In the optical film production line 10, a web W, which is a transparent substrate having a polymer layer formed on its surface, is delivered from delivery machine 66, as shown in FIG. 1. The web W is then guided by guide rollers 68 to be fed into dust removal equipment 74. The dust removal equipment 74 is capable of removing dust deposited on the surface of the web W.

In the downstream of the dust removal equipment 74, the coating head 12 of extrusion coating equipment, as a coating device, is positioned so that a coating solution can be applied to the web W having been wound around a back-up roller 11. The details of the coating head 12 will be described later.

In the downstream of the coating head 12, a drying zone 76 and a heating zone 78 are located in this order so that a liquid crystal layer can be formed on the web W. Further, in the downstream of these two zones, ultraviolet ray irradiation equipment 80, as curing equipment for curing the coating film, is located so that the liquid crystal layer is exposed to ultraviolet rays. The ultraviolet irradiation allows the molecular chains of the liquid crystal to crosslink, thereby forming a desired polymer. The web W having polymer formed on its surface is wound up by wind-up machine 82 located in the downstream of the ultraviolet ray irradiation equipment 80.

Guide rollers 68, 68 . . . are positioned almost throughout the optical film production line 10 in such a manner as to support the web W while allowing it to wind half around them, so that they can convey the web W. The guide rollers 68 are rotatable roller members whose length is almost the same as the width of the web W (in this embodiment, the length is a little larger than the width of the web).

The above described extrusion coating equipment (coating head 12) is particularly effective in applying a thin layer, and thus, it is suitably applied to an optical film production line where application of an ultra-thin layer, that is, application of a coating solution in a wet coating amount of as small as 15 ml/m² or less (wet film thickness at the time of the coating solution application is 15 μm or less) is performed.

In this embodiment, desirably the coating head 12 is positioned in a clean atmosphere such as in a clean room. In this case, the cleanness of the clean atmosphere is preferably class 1000 or lower, more preferably class 100 or lower and much more preferably class 10 or lower.

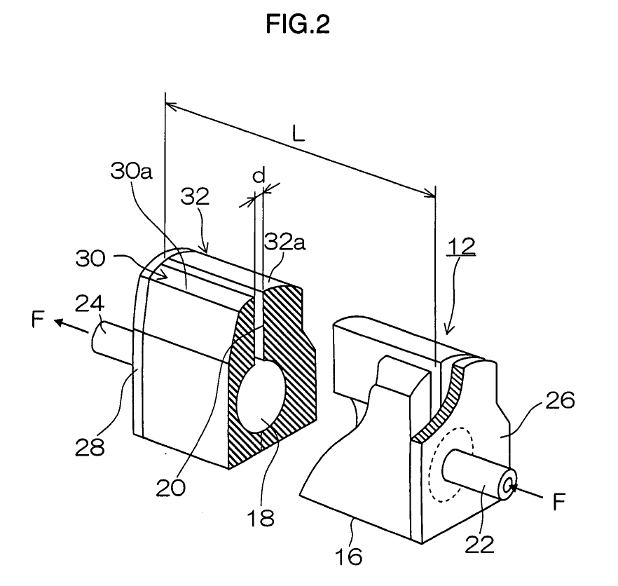

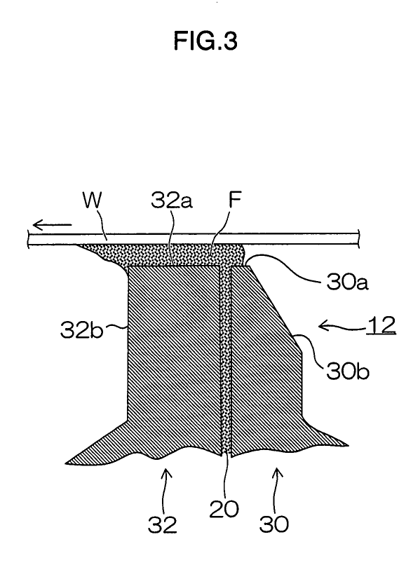

FIG. 2 is a perspective view, partially cut away, showing part of the coating head 12 and FIG. 3 is a schematic cross-sectional view showing the positional relation between the leading edge of the coating head 12 and the web W. The coating head 12 applies a coating solution F, which is fed in the form of a bead from a slot 20, to the web W which is continuously running while being supported by the back-up roller 11, thereby forming a coating film on the web W.

As shown in FIGS. 2 and 3, the coating head 12 is provided with a fluid feeding system, described below, that can feed a coating solution. Specifically, the main body 16 of the coating head 12 includes: a fluid reservoir 18 which extends across the length of the coating head (across the width of the web W); a slot 20 which is in communication with the fluid reservoir 18, faces the web W across the length of the coating head (across the width of the web) and delivers a coating solution through its opening; a fluid-feed opening 22 through which the coating solution is fed to the fluid reservoir 18; and a fluid-discharge opening 24 through which the coating solution is drained from the fluid reservoir 18.

The fluid reservoir 18, also referred to as “pocket” or “manifold”, is a cavity having the fluid reserving function which has an approximately circular cross section and extends across the width of the web W with its cross-sectional shape kept almost the same, as shown in FIG. 2. Usually, the effective length of the fluid reservoir 18 is set so that it is equal to or a little larger than the coating width. The openings of both ends of the fluid reservoir 18 which passes through the man body 16 are closed with closing plates 26, 28 fixed to both ends of the main body 16, as shown in FIG. 2. The foregoing fluid-feed opening 22 and fluid-discharge opening 24 are located on the closing plate 26 and closing plate 28, respectively.

The slot 20, also referred to as “slit”, is a relatively narrow flow path which passes through the inside of the main body 16 of the coating head 12 from the fluid reservoir 18 toward the web W with its opening width (slot clearance) kept 0.01 to 0.5 mm and extends across the width of the web W, like the fluid reservoir 18. The opening length of the slot 20 across the width of the web W is set so that it is almost equal to the coating width.

The distance from the boundary between the slot 20 and the fluid reservoir 18 to the opening of the slot 20 (the length of the flow path toward the web W) can be set appropriately considering various conditions, such as the opening length of the slot 20 across the width of the web W and the composition, physical properties, flow rate and fluid pressure of the coating solution to be fed. As long as a coating solution can be fed in the form of a laminar flow from the slot 20 across the width of the web W at uniform flow rate and fluid pressure distribution, any distance can be employed. For example, when the opening length of the slot 20 across the width of the web W is about 1000 to 1200 mm, the distance in the range of 30 to 80 mm is preferably employed.

In the present invention, the slot width (slot clearance) of the slot 20 is required to be 250 μm or smaller and the ratio of the length L of the slot 20 to the slot width d, L/d, is required to be 300 or higher. The reason for this will be described below.

One of the causes of step unevenness during the application is the pulsation of the coating solution F flowing in the coating head 12. The pulsation of the coating solution F is attributed mainly to: 1) the pulsation of delivery pump (caused by, for example, gear marks when the pump is a gear pump or fluctuations in cycle of diaphragm motion when the pump is a diaphragm pump); or 2) the vibration of coating solution F resulting from the external vibration (e.g. vibration of floor).

Particularly in low-viscosity coating solutions, they are susceptible to vibration, and besides, their delivery amount is small, and therefore, fluctuations in their amount are likely to be a problem. Accordingly, they present problems particularly under the above described conditions.

After directing tremendous research effort toward determining the cause of step unevenness during the application of coating solution, the present inventors found that the pulsation of coating solution F is retarded inside the coating head 12, particularly by the slot 20 part. They also found that if the slot width (slot clearance) of the slot 20 is 250 μm or smaller, and at the same time, the ratio of the length L of the slot 20 to the slot width d, L/d, is 300 or higher, the pulsation of coating solution F can be damped and the step unevenness of the resultant coating film can be decreased to a level which is not a problem.

The effect of retarding the occurrence of step unevenness is remarkable in low-viscosity coating solutions F in which pulsation is more likely to occur. Further, the effect of reducing the pulsation is relatively large during the application of coating solution F in a small amount, and thus, the effect of retarding the occurrence of step unevenness is large.

It has been pointed out that if the slot width (slot clearance) d is decreased (narrowed) at the same time that the length L of the slot 20 is increased (elongated), coating solution cannot be delivered depending on the power of the pump used, because this increases the pressure loss of the coating solution F passing through the slot 20. However, in the present invention, since coating is performed using a low-viscosity coating solution F in a low amount, the pressure loss tends to be decreased, and therefore there is no serious problem.

The width of the fluctuation in the slot width d (slot clearance) of the slot 20 affects the coating amount distribution across the width of the web W and the more the slot clearance d is decreased (narrowed), the more the effect is increased. Thus, it is not preferable to decrease (narrow) the slot clearance d too much. Preferably, the slot clearance d is 50 μm or larger and 250 μm or smaller.

The ratio of the length L of the slot 20 to the slot width d, L/d, has no upper limit, but preferably the ratio is 300 or higher and 1000 or lower.

In the following, the leading edge portion of the coating head 12 will be described with reference to FIG. 3. The slot 20 is formed by the front edge 30 and the back edge 32 of the main body 16 (refer to FIG. 2) of the coating head 12. On the top surface (the surface facing to the web W) of the main body 16 of the coating head 12, a front edge surface 30a (front end lip) and a back edge surface 32a (rear end lip) are formed from the upstream downward. As shown in FIG. 3, the front edge surface 30a and back edge surface 32a are so formed that their cross section is almost linear.

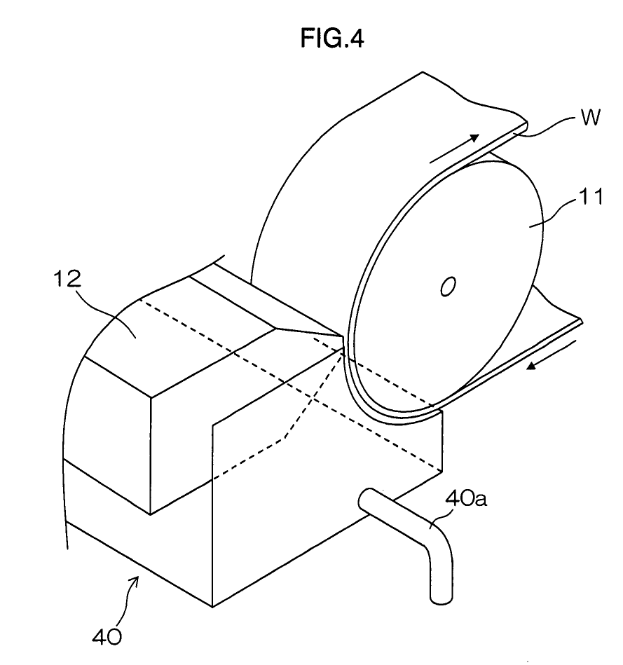

In the following a vacuum chamber 40 will be described. FIG. 4 is a perspective view showing the coating head 12 and its vicinities. In order to fully make the vacuum adjustment of the beads of coating solution F, on the opposite side of the coating head 12 to the direction of the web W running, a vacuum chamber 40 is provided in such a position that it does not come in contact with the web W.

To the vacuum chamber 40, is connected vacuum piping 40a which is also connected to a vacuum device (blower, vacuum pump or the like), whereby the inside of the vacuum chamber 40 is kept in the vacuum state. However, the vacuum chamber 40 is not indispensable to the present invention.

In the following various materials used in the present invention will be described. As a web W which can be used not only for optical films, but for many applications, a resin film, paper (resin coated paper, synthetic paper or the like) or metal foil (an aluminum web etc.) can be used. As a material for the resin film, any known material such as polyethylene, polypropylene, polyvinyl chloride, polyvinylidene chloride, polyvinyl acetate, polystyrene, polycarbonate, polyamide, PET (polyethylene terephthalate), biaxially oriented polyethylene terephthalate, polyethylene naphthalate, polyamide-imide, polyimide, aromatic polyamide, cellulose triacetate, cellulose acetate propionate or cellulose diacetate can be used. Of these materials, polyethylene terephthalate, polyethylene naphthalate and polyamide are particularly preferably used.

A web W employed is generally, not limited to, 0.1 to 3 m wide, 1000 to 100000 m long and 0.5 to 300 μm thick.

The web W may undergo, in advance, treatment such as corona discharge treatment, plasma treatment, easy-to-bind treatment, heat treatment or dust removing treatment.

Or a web W having been provided with a primary coat such as an adhesive layer and cured by drying or a web W having some other functional layer formed on its back side may also be used.

As a composition of coating solution, any one can be selected from among various known compositions depending on the objective.

In the following, the construction of an antireflection film, as one example of the optical films of the present invention, will be described. The number of layers that constitute an antireflection film can be selected depending on the objective; however, to realize low reflection in a wide wave-length region, the number is preferably 3 or more. For three-layer antireflection films, a design is known in which an intermediate-refractive-index layer, a high-refractive-index layer and a low-refractive index layer are layered from the substrate side upward in this order and the optical thicknesses of the respective layers, in other words, the products of the refractive index and the physical thickness are λ/4, λ/4 and λ/4 or λ/4, λ/2 and λ/4, respectively, where λ represents the designed wavelength, as described in “Hansha Boshimaku no Tokusei to Saiteki Sekkei-Maku Sakusei Gijyutsu (Properties of Antireflection Film and Optimal Design and Film Forming Technology)”, published by TECHNICAL INFORMATION INSTITUTE CO., LTD, pp. 15 to 16, Feb. 5, 2002.

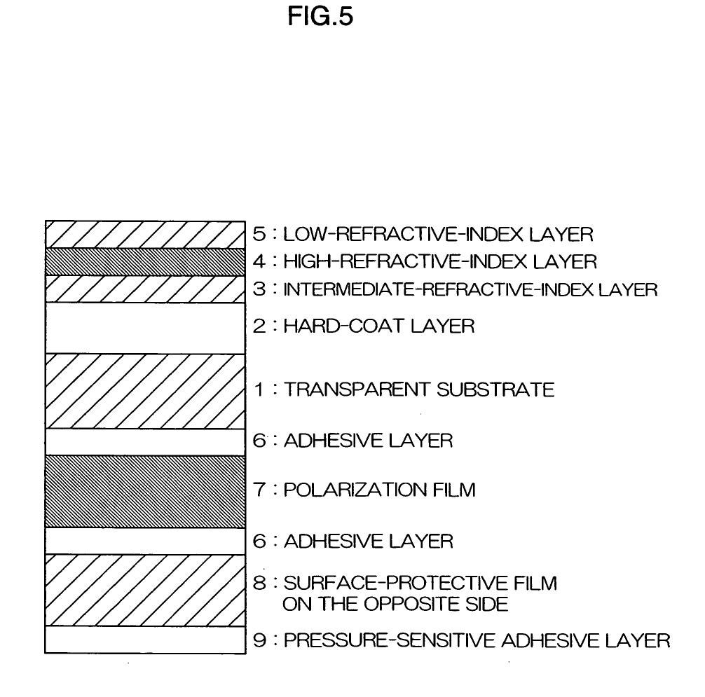

FIG. 5 is a schematic cross-sectional view showing the layer construction of a sheet polarizer in which a multi-layer antireflection film having an excellent antireflection performance is used as a surface-protective film on one side. The sheet polarizer has layer construction that includes: a transparent substrate 1 (web W), a hard coat layer 2, an intermediate-refractive-index layer 3, a high-refractive-index layer 4 and a low-refractive index layer (outermost layer) 5 in this order.

The layers that constitute the antireflection film will be described in detail below.

The transparent substrate 1 is preferably a plastic film. Plastic films applicable include films of: cellulose ester (e.g. triacetyl cellulose, diacetyl cellulose, propionyl cellulose, butylyl cellulose, acetylpropionyl cellulose and nitrocellulose); and polyolefin (e.g. polypropylene, polyethylene and polymethylpentene). Of these plastic films, films of triacetyl cellulose or polyolefin are preferably used for the sheet polarizer application, because they have a small retardation value and high optical uniformity. For the liquid crystal display application, a triacetyl cellulose film is particularly preferable.

As a triacetyl cellulose film, one disclosed in Japanese Patent Application Laid-Open No. 2001-1745 is preferably used.

The hard coat layer is positioned on the surface of the transparent substrate so as to impart physical strength to the antireflection film.

Preferably the hard coat layer is formed by crosslinking reaction or polymerization reaction of ionizing-radiation-curable compounds. For example, it can be formed by applying a coating composition that includes ionizing-radiation-curable polyfunctional monomers or oligomers to the surface of a transparent substrate and subjecting the monomers or oligomers to crosslinking or polymerization reaction. The hard coat layer may include inorganic fine particles so that its refractive index or strength is adjusted.

As functional groups of ionizing-radiation-curable polyfunctional monomers or oligomers, photo-, electron-radiation-induction- or irradiation-induction-polymerizable functional groups are preferable, and photopolymerizable functional groups are particularly preferable.

Examples of photopolymerizable functional groups include: unsaturated polymerizable functional groups such as (metha)acryloyl, vinyl, styryl and allyl groups. Of these functional groups, (metha)acryloyl functional group is preferable.

Specific examples of photopolymerizable functional monomers having photopolymerizable functional group include: (meth)acrylate diesters of alkyleneglycol such as neopentylglycol acrylate, 1,6-hexanediol (meth)acrylate and propyleneglycol di(meth)acrylate; (meth)acrylate diesters of polyoxyalkyleneglycol such as triethyleneglycol di(meth)acrylate, dipropyleneglycol di(methacrylate), polyethyleneglycol di(meth)acrylate and polypropyleneglycol di(meth)acrylate; (meth)acrylate diesters of polyhydric alcohol such as pentaerythritol di(meth)acrylate; and (meth)acrylate diesters of ethylene oxide or propylene oxide adduct such as 2,2-bis{4-(acryloxy-diethoxy}phenyl propane and 2-2-bis{4-(acryloxy-polypropoxy)phenyl}propane.

Epoxy (meth)acrylates, urethane (meth)acrylates and polyester (meth)acrylates are also preferably used as photopolymerizable functional monomers.

Of the above described monomers, esters of polyhydric alcohol and (meth)acrylic acid are preferable. Further preferable are polyfunctional monomers having 3 or more (meth)acryloyl groups per molecule. Specific examples of such monomers include: trimethylolpropane tri(meth)acrylate, trimethylolethane tri(meth)acrylate, 1,2,4-cyclohexane tetra(meth)acrylate, pentaglycerol triacrylate, pentaerythritol tetra(meth)acrylate, pentaerythritol tri(meth)acrylate, dipentaerythritol triacrylate, dipentaerythritol pentacrylate, dipentaerythritol tetra(meth)acrylate, dipentaerythritol hexa(meth)acrylate, tripentaerythritol triacrylate and tripentaerythritol hexatriacrylate.

The descriptions “(meth)acrylate”, “(meth)acryloyl” and the like herein mean “acrylate or methacrylate”, “acryloyl or methacryloyl” and the like, respectively.

Two or more kinds of polyfunctional monomers can be used together.

For polymerization reaction of photopolymerizable polyfunctional monomers, preferably a photo initiator is used. As a photo initiator, a photoradical initiator or photocationic initiator is preferable, and a photoradical initiator is particularly preferable.

Examples of photoradical initiators include: acetophenones, benzophenones, Michler's benzoyl benzoates, α-amyloxime esters, tetramethylthiuram monosulfides and thioxanthones.

Commercially available photoradical initiators include: for example, KAYACURE (DETX-S, BP-100, BDMK, CTX, BMS, 2-EAQ, ABQ, CPTX, EPD, ITX, QTX, BTC, MCA, etc.) manufactured by NIPPON KAYAKU CO., LTD.; Irugacure (651, 184, 500, 907, 369, 1173, 2959, 4265, 4263, etc.) manufactured by Nihon Ciba-Geigy K.K.; and Esacure (KIP100F, KB1, EB3, BP, X33, KT046, KT37, KIP150, TZT) manufactured by Sartomer Company Inc.

Photocleavage initiators are particularly preferable. Photocleavage initiators are described in Saishin UV Koka Gijutsu (Advanced UV Curing Techniques) (published by Kazuhiro Takausu (publisher), TECHNICAL INFORMATION INSTITUTE CO., LTD, p. 159, 1991).

Commercially available photocleavage initiators include, for example, Irugacure (651, 184, 907) manufactured by Nihon Ciba-Geigy K.K.

Preferably photo initiator is used in an amount in the range of 0.1 to 15 parts by mass per 100 parts of polyfunctional monomers and more preferably in the range of 1 to 10 parts by mass.

In addition to photo initiator, photosensitizer may also be used. Specific examples of photosensitizers include: n-butylamine, triethylamine, tri-n-butyl phosphine, Michler's ketone and thioxanthones.

Examples of commercially available photosensitizers include: KAYACURE (DMBI, EPA) manufactured by NIPPON KAYAKU CO., LTD.

Preferably the photopolymerization is performed, after application and drying of the layer, by ultraviolet ray irradiation.

To the hard coat layer, olygomer having a weight average molecular weight of 500 or more and/or polymer may be added so as to impart brittleness to the layer.

Examples of oligomers and polymers used for such purpose include: (meth)acrylate-, cellulose- or styrene-based polymers; urethane acrylate; and polyester acrylate. Preferable are poly(glycidyl(meth)acrylate) and poly(allyl(meth)acrylate) having functional group on their side chains.

The content of oligomer and/or polymer in the hard coat layer is preferably 5 to 80% by mass of the total mass of the hard coat layer, more preferably 25 to 70% by mass and particularly preferably 35 to 65% by mass.

Mat particles may be added to the hard coat layer so as to impart antiglare property to the layer.

Preferably the strength of the hard coat layer is “H” or higher based on the pencil hardness test in accordance with JIS K5400, more preferably “2H” or higher, and most preferably “3H” or higher.

Preferably the test pieces of the hard coat layer have small abrasion loss when they undergo Taber abrasion test in accordance with JIS K5400.

When the hard coat layer is formed by crosslinking reaction or polymerization reaction of ionizing-radiation-curable compounds, preferably the crosslinking reaction or polymerization reaction is performed in an atmosphere whose oxygen concentration is 2% by volume or lower. The hard coat layer formed in an atmosphere whose oxygen concentration is 2% by volume or lower has excellent physical strength and chemical resistance.

Preferably the hard coat layer is formed by crosslinking reaction or polymerization reaction of ionizing-radiation-curable compounds in an atmosphere whose oxygen concentration is 0.5% by volume or lower, more preferably 0.1% by volume or lower, and most preferably 0.05% by volume or lower.

A preferable technique for preparing an atmosphere whose oxygen concentration is 2% by volume or lower is to replace atmospheric air (nitrogen concentration: about 79% by volume, oxygen concentration: about 21% by volume) with another gas. A particularly preferable technique is to replace atmospheric air with nitrogen (conduct a nitrogen purge).

Preferably the hard coat layer is constructed by applying a coating composition for hard coat layer to the surface of the transparent substrate.

As a coating solvent, preferably a ketone solvent is used. Use of a ketone solvent further improves the adhesion between the surface of the transparent substrate (particularly triacetyl cellulose substrate) and the hard coat layer.

Particularly preferable coating solvents are methyl ethyl ketone, methyl isobutyl ketone and cyclohexanone.

The coating solvent used may include solvents other than a ketone solvent.

Preferably the ketone solvent content of the entire solvent contained in the coating composition is 10% by mass or higher, preferably 30% by mass or higher, and more preferably 60% by mass or higher.

In the present invention, the refractive index of the high-refractive-index layer in the antireflection film is 1.60 to 2.40 and more preferably 1.70 to 2.20. The refractive index of the intermediate-refractive-index layer is adjusted so that it has a value between the refractive index of the low-refractive-index layer and that of the high-refractive-index layer. The refractive index of the intermediate-refractive-index layer is preferably 1.55 to 1.80. The haze of the high-refractive-index layer and the intermediate-refractive-index layer is preferably 3% or lower.

In the present invention, as the high-refractive-index layer and the intermediate-refractive-index layer, a cured product of a composition in which inorganic fine particles having a high refractive index are dispersed in a monomer, initiator and organic-substituted silicon compound is preferably used. As inorganic fine particles, fine particles of metal (e.g. aluminum, titanium, zirconium or antimony) oxide are preferably used. From the viewpoint of refractive index, fine particles of titanium dioxide are most preferably used. When monomer and initiator are used, if the monomer is cured by polymerization reaction with the aid of ionizing-radiation or heat after the application, the resultant intermediate-refractive-index layer or high-refractive-index layer has excellent scratch resistance and adhesion. Preferably the average particle size of inorganic fine particles is 10 to 100 nm.

In the present invention, preferably the inorganic fine particles containing titanium dioxide as a chief ingredient have a refractive index of 1.90 to 2.80, more preferably 2.10 to 2.80, and most preferably 2.20 to 2.80.

Preferably, the weight average particle size of the primary particles of the inorganic fine particles that contain titanium dioxide as a chief ingredient is 1 to 200 nm, more preferably 1 to 150 nm, much more preferably 1 to 100 nm, and particularly preferably 1 to 80 mm.

The particle size of the inorganic fine particles can be determined by light scattering or electron micrographs. Preferably the specific surface area of the inorganic fine particles is 10 to 400 m²/g, more preferably 20 to 200 m²/g, and most preferably 30 to 150 m²/g.

Preferably the crystal structure of the inorganic fine particles that contain titanium dioxide as a chief ingredient is made up mainly of rutil, rutile/anatase mixed crystal, anatase or amorphous structure. Particularly preferably the crystal structure is made up mainly of rutil structure.

If the inorganic fine particles that contain titanium dioxide as a chief ingredient also include any one element selected from the group consisting of Co (cobalt), Al (aluminum) and Zr (zirconium), the photocatalytic activity of titanium dioxide can be suppressed, whereby the weathering resistance of high-refractive-index and intermediate-refractive-index layers of the present invention can be improved.

Particularly preferable element is Co (cobalt). Using two or more kinds of such elements together is also preferable.

In the present invention, to disperse the inorganic fine particles that contain titanium dioxide as a chief ingredient and are used for high-refractive-index and intermediate-refractive-index layers, dispersant can be used.

In the present invention, to disperse the inorganic fine particles that contain titanium dioxide as a chief ingredient, it is preferable to use dispersant that includes anionic groups.

As anionic groups, groups containing acidic proton, such as carboxyl, sulfonic (and sulfo), phosphoric (and phosphono) and sulfonamide group, or the salts thereof are effective. Of these groups, carboxyl, sulfonic and phosphoric groups and the salts thereof are preferable, and carboxyl and phosphoric groups are particularly preferable. The number of anionic groups contained per unit molecule of dispersant is not limited, as long as one or more anionic groups are contained.

In order to further improve the dispersibility of the inorganic fine particles, a plurality of anionic groups may be contained in the dispersant. Preferably the number is, on average, 2 or more, more preferably 5 or more and particularly preferably 10 or more. Further, more than one kind of anionic group may be contained per unit molecule of dispersant.

Preferably the dispersant also includes a crosslinkable or polymerizable group. Examples of such crosslinkable or polymerizable groups include: ethylenic unsaturated groups capable of undergoing addition reaction/polymerization reaction by a radical species (e.g. (meth)acryloyl, allyl, styryl and vinyloxy groups); cationically polymerizable groups (e,g, epoxy, oxetanyl and vinyloxy groups); and polycondesable groups (e.g. hydrolysable silyl and N-methylol groups). Preferably crosslinkable or polymerizable groups are functional groups including ethylenic unsaturated groups.

In the present invention, the dispersant preferably used for dispersing inorganic fine particles which contain titanium dioxide as a chief ingredient and are used for high-refractive-index layer is dispersant that includes anionic groups and a crosslinkable or polymerizable functional group, wherein the crosslinkable or polymerizable functional group is on the side chain of the dispersant molecule.

The weight average molecular weight (Mw) of the dispersant that includes anionic groups and a crosslinkable or polymerizable functional group, wherein the crosslinkable or polymerizable functional group is on the side chain of the dispersant molecule, is preferably, not limited to, 1000 or larger. The weight average molecular weight (Mw) of the dispersant is more preferably 2000 to 1000000, much more preferably 5000 to 200000 and particularly preferably 10000 to 100000.

The amount of the dispersant used is preferably in the range of 1 to 50% by mass per 100% of inorganic fine particles, more preferably in the range of 5 to 30% by mass and most preferably 5 to 20% by mass. Two or more kinds of dispersant may also be used together.

The inorganic fine particles that contain titanium dioxide as a chief ingredient and are used for high-refractive-index and intermediate-refractive-index layers are used in the form of dispersion for forming high-refractive-index and intermediate-refractive-index layers.

The inorganic fine particles are dispersed in a dispersion medium in the presence of the above described dispersant.

As a dispersion medium, preferably a liquid having a boiling point of 60 to 170° C. is used. Examples of dispersion medium used include: water, alcohols (e.g. methanol, ethanol, isopropanol, butanol, benzyl alcohol); ketones (e.g. acetone, methyl ethyl ketone, methyl isobutyl ketone, cyclohexanone); esters (e.g. methyl acetate, ethyl acetate, propyl acetate, butyl acetate, methyl formate, ethyl formate, propyl formate, butyl formate); aliphatic hydrocarbons (e.g. hexane, cyclohexane); halogenated hydrocarbons (e.g. methylene chloride, chloroform, carbon tetrachloride); aromatic hydrocarbons (e.g. benzene, toluene xylene); amides (e.g. dimethylformamide, dimethylacetamide, n-methylpyrrolidone); ethers (e.g. diethyl ether, dioxane, tetrahydrofuran); and ether alcohols (e.g. 1-methoxy-2-propanol). Of these dispersion media, toluene, xylene, methyl ethyl ketone, methyl isobutyl ketone, cyclohexanone and butanol are preferable.

Particularly preferable dispersion media are methyl ethyl ketone, methyl isobutyl ketone and cyclohexanone.

The inorganic fine particles are dispersed with disperser. Examples of disperser include: sand grinder mill (e.g. bead mill with pin), high-speed impeller mill, pebble mill, roller mill, attritor and colloid mill. Sand grinder mill and high-speed impeller mill are particularly preferable. Pre-dispersion treatment may also be performed. Examples of disperser used for pre-dispersion treatment include: ball mill, triple roll mill, kneader and extruder.

Preferably the inorganic fine particles exist in the finest possible state in a dispersion medium. The weight average particle size of the inorganic fine particles is 1 to 200 nm, preferably 5 to 150 nm, much more preferably 10 to 100 nm and particularly preferably 10 to 80 nm.

If the inorganic fine particles are allowed to be as fine as 200 nm or less, high-refractive-index and intermediate-refractive-index layers both having good transparency can be formed.

Preferably the high-refractive-index and intermediate-refractive-index layers used in the present invention are formed in such a manner as to: prepare a coating composition for forming high-refractive-index and intermediate-refractive-index layers by adding a binder precursor required for forming a matrix (such as ionizing-radiation curable polyfunctional monomer or polyfunctional oligomer described in connection with hard coat layer) and photo initiator to a dispersion prepared by dispersing inorganic fine particles in a dispersion medium in the above described manner; applying the coating composition for forming high-refractive-index and intermediate-refractive-index layers to a transparent substrate; and curing the coating solution by the crosslinking reaction or polymerization reaction of the ionizing-radiation curable compound.

Further, preferably the binder of the high-refractive-index and intermediate-refractive-index layers is allowed to be crosslinked or polymerized with the dispersant at the same time as or after the application of the layers.

In the binder of the high-refractive-index and intermediate-refractive-index layers thus formed, the above described preferable dispersant is crosslinked or polymerized with ionizing-radiation curable polyfunctional monomer or polyfunctional oligomer; as a result, the anionic groups of the dispersant are entrapped in the binder. Further, in the binder of the high-refractive-index and intermediate-refractive-index layers, the anionic groups have the function of keeping the inorganic fine particles in the dispersed state. Besides, the crosslinked or polymerized structure imparts film-forming capability to the binder. Thus, the physical strength, chemical resistance and weathering resistance of the high-refractive-index and intermediate-refractive-index layers that include the inorganic fine particles are improved.

To the high-refractive-index and intermediate-refractive-index layers, besides the above described ingredients (inorganic fine particles, polymerization initiator, photosensitizer, etc.), ingredients such as resin, surfactant, antistatic agent, coupling agent, thickener, anticolorant, colorant (pigment, dye), antifoam, leveling agent, flame-retardant, ultraviolet absorber, infrared absorber, adhesion imparting agent, polymerization inhibitor, antioxidant, surface modifier or conductive metal fine particles may also be added.

Since the high-refractive-index layer is laid just beneath the low-refractive-index layer, in order to provide adhesion between the low-refractive-index layer and the high-refractive-index layer, it is necessary to adjust the surface roughness and curing conditions.

The surface roughness (Ra) can be determined with atomic force microscope. To improve interlaminar bonding, preferably the surface roughness is 1 nm or more, more preferably 2 nm or more and most preferably 3 nm or more. The surface roughness of 20 nm or more is, however, not preferable because it may increase the haze of the resultant film or it may make it impossible to ignore the refractive index gradient occurring between the low-refractive-index layer and the high-refractive-index layer. Since the surface roughness varies depending on the amount or particle size of the inorganic fine particles added to the high-refractive-index layer or the thickness of the high-refractive-index layer, the amount or particle size or the thickness requires adjustment.

In order to improve the adhesion of the high-refractive-index layer to the low-refractive-index layer, it is necessary to allow the bonding groups left unreacted to reside on the surface of the high-refractive-index layer at the time of low-refractive-index layer application. Thus, preferably the high-refractive-index layer is kept in the half-cured state.

The amount of the residual double bond depends on the oxygen concentration, irradiance or irradiation dose during curing, or the kind or amount of the initiator used.

The slower the curing progresses, the more the residual double bond increases. However, if the curing is allowed to progress too slow, interfacial mixing with the high-refractive-index layer occurs during low-refractive-index layer formation. This may make controlling the optical characteristics impossible or the flatness of the resultant film poor, and therefore, not preferable.

The amount of the residual double bond on the surface of the high-refractive-index layer can be quantified by measuring the peak intensity of the unsaturated bond, which is modified with bromine in advance, with ESCA. The residual rate of the double bond on the surface of the sublayer can be expressed by the ratio between the amount of the double bond on the surface before curing, A, and the amount of the residual double bond on the surface after curing, B. The value B/A which is closer to 0 means that the curing progresses more completely. From the foregoing viewpoint, the residual rate B/A is preferably 0.2 to 0.9 and more preferably 0.3 to 0.8.

Preferably the low-refractive-index layer is formed of the cured film of copolymer that contains a repeating unit derived from fluorine-containing vinyl monomer and a repeating unit having (meth)acryloyl group on its side chain as essential ingredients. Preferably the ingredient resulting from the copolymer accounts for 20% by mass or more of the film resin ingredients, more preferably 40% by mass or more and particularly preferably 80% by mass or more. From the viewpoint of providing the layer with a low refractive index and film hardness, a curing agent such as polyfunctional (meth)acrylate can also be preferably used, as long as it does not worsen the compatibility with the other ingredients.

Preferably the refractive index of the low-refractive-index layer is 1.20 to 1.50, more preferably 1.25 to 1.48, and particularly preferably 1.30 to 1.46.

Preferably the thickness of the low-refractive-index layer is 50 to 200 nm and more preferably 70 to 130 nm. Preferably the haze of the low-refractive-index layer is 3% or lower, more preferably 2% or lower, and most preferably 1% or lower. Preferably the specific strength of the low-refractive-index layer is “H” or higher, more preferably “2H” or higher, and most preferably “3H” or higher, based on the pencil hardness test with 500 g load.

To improve the antifouling performance of the antireflection film, preferably the surface of the low-refractive-index layer has a water contact angle of 90° or larger, more preferably 95° or larger, and particularly preferably 100° or larger.

In the following the copolymer used for the low-refractive-index layer will be described.

Examples of fluorine-containing vinyl monomers used include: fluoroolefins (e.g. fluoroethylene, vinylidene fluoride, tetrafluoroethylene, hexafluoropropylene); partially or completely fluorinated alkyl ester derivatives of (meth)acrylic acid (e.g. Viscoat 6FM (trade name, manufactured by OSAKA ORGANIC CHEMICAL INDUSTRY LTD.), M-2020 (trade name, manufactured by DAIKIN INDUSTRIES, ltd.)); and completely or partially fluorinated vinyl ethers. Of these monomers, perfluoroolefins are preferably used, and from the viewpoint of refractive index, solubility, transparency and availability, hexafluoropropylene is particularly preferably used. If the ratio of the fluorine-containing vinyl monomer in the composition is increased, the film strength of the low-refractive-index layer is lowered, though the refractive index of the same can be lowered. In the present invention, preferably the fluorine-containing vinyl monomer is introduced so that the fluorine content of the copolymer is 20 to 60% by mass, more preferably 25 to 55% by mass, and particularly preferably 30 to 50% by mass.

Preferably the copolymer contains, as an essential ingredient, a repeating unit having (meth)acryloyl group on its side chain. If the ratio of the (meth)acryloyl group-containing repeating unit in the composition is increased, the refractive index of the low-refractive-index layer is increased, though the film strength of the same is improved. Generally, preferably the (meth)acryloyl group-containing repeating unit accounts for 5 to 90% by mass of the copolymer, more preferably 30 to 70% by mass, and particularly preferably 40 to 60% by mass, though the preferable amount varies depending on the kind of the repeating unit derived from fluorine-containing vinyl monomer.

In useful copolymers, besides the above described repeating unit derived from fluorine-containing vinyl monomer and repeating unit having (meth)acryloyl group on its side chain, some other vinyl monomer can also be properly copolymerized, from various viewpoints, such as solubility in a solvent, transparency, slip properties and dust-proof/stain-proof properties. A plurality of these vinyl monomers may also be used in combination depending on the objective. Preferably the total amount of such vinyl monomers introduced in the copolymer is in the range of 0 to 65% by mol, more preferably in the range of 0 to 40% by mol, and particularly preferably in the range of 0 to 30% by mol.

Vinyl monomer units used together include: for example, not limited to, olefins (e.g. ethylene, propylene, isoprene, vinyl chloride, vinylidene chloride); acrylic esters (e.g. methyl acrylate, ethyl acrylate, 2-ethylhexyl acrylate, 2-hydroxyethyl acrylate); methacrylic esters (e.g. methyl methacrylate, ethyl methacrylate, butyl methacrylate, 2-hydroxyethyl methacrylate); styrene derivatives (e.g. styrene, p-hydroxymethylstyrene, p-methoxystyrene); vinyl ethers (e.g. methyl vinyl ether, ethyl vinyl ether, cyclohexyl vinyl ether, hydroxyethyl vinyl ether, hydroxybutyl vinyl ether); vinyl esters (e.g. vinyl acetate, vinyl propionate, vinyl cinnamate); unsaturated carboxylic acids (e.g. acrylic acid, methacrylic acid, crotonic acid, maleic acid, itaconic acid); acrylamides (N,N-dimethyl acrylamide, N-tert-butyl acrylamide, N-cyclohexyl acrylamide); methacrylamides (N,N-dimethyl methacrylamide); and acryintriles.

A preferred form of the copolymer used in the present invention is expressed by the following general formula 1. 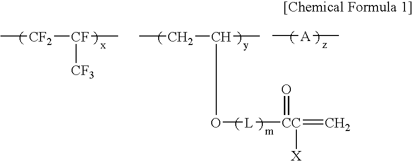
In the general formula 1, L represents a C₁₋₁₀ linking group, more preferably a C₁₋₆ linking group, and particularly preferably a C₂₋₄ linking group, which may has a straight or branched chain structure or a ring structure and optionally includes a hetero atom selected from the group consisting of O, N and S.

Preferred examples of such linking groups include: *—(CH2)2-O—**, * —(CH2)2-NH—**, —(CH2)4-O—**, *—(CH2)6-O—**, *—(CH2)2-O—(CH2)2-O—**, —CONH—(CH2)3-O—**, *—CH2CH(OH)CH2-O—*, and *—CH2CH2OCONH(CH2)3-O—** (* represents a linking position on the polymer backbone side, while ** a linking position on the acryloyl group side). In the general formula 1, m is 0 or 1.

In the general formula 1, X represents a hydrogen atom or methyl group. From the viewpoint of curing reactivity, preferably X is a hydrogen atom.

In the general formula 1, A represents a repeating unit derived from any one of vinyl monomers, which is not limited to any specific one as long as it is a monomer ingredient copolymerizable with hexafluoropropylene. A can be selected appropriately from various viewpoints, such as adhesion to a substrate, Tg of polymer (contributes to film strength), solubility in a solvent, transparency, slip properties, or dust-proof/stain-proof properties. It may be composed of a single vinyl monomer or a plurality of vinyl monomers depending on the objective.

Preferred examples of repeating units represented by A include: vinyl ethers such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether and allyl vinyl ether; vinyl esters such as vinyl acetate, vinyl propionate and vinyl butyrate; (meth)acrylates such as methyl (meth)acrylate, ethyl (meth)acrylate, hydroxyethyl (meth)acrylate, glycidyl methacrylate, allyl (meth)acrylate and (meth)acryloyl oxypropyl trimethoxysilane; styrene derivatives such as styrene and p-hydroxymethylstyrene; unsaturated carboxylic acids such as crotonic acid, maleic acid and itaconic acid; and the derivative thereof. More preferred examples include: vinyl ether derivatives and vinyl ester derivatives, and particularly preferred examples are vinyl ether derivatives.

In the general formula 1, x, y and z each represent a molar percentage value and their values satisfy the following expressions: 30≦x≦60, 5≦y≦70, and 0≦z≦65, preferably 35≦x≦55, 30≦y≦60, and 0≦z≦20, and particularly preferably 40≦x≦55,40≦y≦55, and 0≦z≦10.

A particularly preferred form of the copolymer used in the present invention is expressed by the following general formula 2. 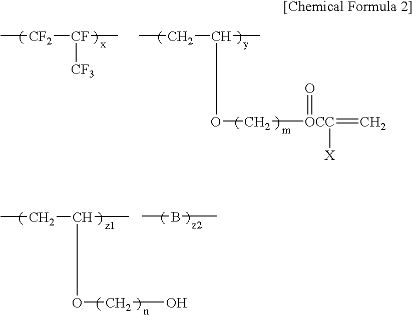
In the general formula 2, X, x and y each represent the same as those of general formula 1 and their preferred ranges are also the same as those of general formula 1.

In the general formula 2, n is an integer that satisfies the following expression: 2≦n≦10, preferably 2≦n≦6, and particularly preferably 2≦n≦4.

In the general formula 2, B represents a repeating unit derived from any one of vinyl monomers, which may be composed of a single vinyl monomer or a plurality of vinyl monomers. The above described examples of repeating units represented by A apply to the examples of vinyl monomers represented by B.

In the general formula 2, z1 and z2 each represent a molar percentage value and their values satisfy the following expressions: 0≦z1≦65 and 0≦z2≦65, preferably 0≦z1≦30 and 0≦z2≦10, and particularly preferably 0≦z1≦10 and 0≦z2≦5.

The copolymer represented by the general formula 1 or 2 can be synthesized by, for example, introducing (meth)acryloyl group into copolymer that includes a hexafluoropropylene ingredient and a hydroxyalkyl vinyl ether ingredient by any one of procedures described above.

The low-refractive-index layer forming composition used in the present invention usually takes the form of a liquid and is prepared by using the above described copolymer as an essential ingredient and, depending on the situation, adding a solution of various kinds of additives and radical initiator in an appropriate solvent. The solid content of the composition is properly selected depending on the objective; however, the solid content is generally about 0.01 to 60% by mass, preferably 0.5 to 50% by mass, and particularly preferably 1% to 20% by mass.

As described above, from the viewpoint of the film strength of the low-refractive-index layer, adding additives such as a curing agent is not necessarily advantageous; however, from the viewpoint of interfacial adhesion to the high-refractive-index layer, a curing agent, such as a polyfunctional (meth)acrylate compound, polyfunctional epoxy compound, polyisocianate compound, aminoplast, polybasic acid or anhydride thereof, or inorganic fine particles of, for example, silica can also be added in a small amount. When these additives are added, preferably the amount of the additives added is in the range of 0 to 30% by mass of the total solid content of the low-refractive-index layer, more preferably in the range of 0 to 20% by mass, and particularly preferably in the range of 0 to 10% by mass.

In order to provide properties such as stain-proof properties, water resistance, chemical resistance or slip properties, known silicone or fluorine stain-proofing agent, slip agent, etc. can also be added properly. When these additives are added, preferably the amount of the additives added is in the range of 0 to 20% by mass of the total solid content of the low-refractive-index layer, more preferably in the range of 0 to 10% by mass, and particularly preferably in the range of 0 to 5% by mass.

As a radical initiator, any one of the initiator that produces radicals by the action of heat and the initiator that produces radicals by the action of light can be used.

As a compound that initiates radical polymerization by the action of heat, an organic or inorganic peroxide, or an organic azo or diazo compound can be used.

Specific examples of organic peroxides include: benzoyl peroxide, halogen benzoyl peroxide, lauroyl peroxide, acetyl peroxide, dibutyl peroxide, cumene hydroperoxide and butyl hydroperoxide. Specific examples of inorganic peroxides include: hydrogen peroxide, ammonium persulfate and potassium persulfate. Specific examples of azo compounds include: 2-azo-bis-isobutylnitrile, 2-azo-bis-propionitrile and 2-azo-bis-cyclohexanedinitrile. Specific examples of diazo compounds include: diazoaminobenzene and p-nitrobenzenedizonium.

When a compound is used which initiates radical polymerization by the action of light, the film is cured by irradiation of activation energy ray.

Examples of such photoradical initiators include: acetophenones, benzoins, benzophenones, phosphine oxides, ketals, anthraquinones, thioxanthones, azo compounds, peroxides, 2,3-dialkyldione compounds, disulfide compounds, fluoroamine compounds and aromatic sulfoniums. Examples of acetophenones include: 2,2-diethoxyacetophenone, p-dimethylacetophenone, 1-hydroxydimethyl phenyl ketone, 1-hydroxycyclohexyl phenyl ketone, 2-methyl-4-methylthio-2-morpholinopropiophenone and 2-benzyl-2-dimethylamino-1-(4-morpholinophenyl)-butanone. Examples of benzoins include: benzoin benzenesulfonate ester, benzoin toluenesulfonate ester, benzoin methyl ether, benzoin ethyl ether and benzoin isopropyl ether. Examples of benzophenones include: benzophenone, 2,4-dichlorobenzophenone, 4,4-dichlorobenzophenone and p-chlorobenzophenone. Examples of phosphine oxides include: 2,4,6-trimethylbenzoyl-diphenyl phosphine oxide. Sensitizing dye can also be preferably used in combination with any of these photoradical initiators.

The compound which initiates radical polymerization by the action of heat or light may be added in any amount, as long as the amount enables the polymerization of carbon-carbon double bond to be initiated. Generally, preferably the amount is 0.1 to 15% by mass of the total solid content of the low-refractive-index layer, more preferably 0.5 to 10% by mass, and particularly preferably 2 to 5% by mass.

As a solvent contained in the coating solution composition for low-refractive-index layer, any solvent can be used as long as it can dissolve or disperse the ingredients without forming sediments. Two or more kinds of solvents can also be used together. Preferred examples of solvents include: ketones (e.g. acetone, methyl ethyl ketone, methyl isobutyl ketone); esters (e.g. ethyl acetate, butyl acetate); ethers (e.g. tetrahydrofuran, 1,4-dioxane); alcohols (e.g. methanol, ethanol, isopropyl alcohol, butanol, ethylene glycohol); aromatic hydrocarbons (e.g. toluene, xylene); and water.

Preferably the low-refractive-index layer may contain, besides a fluorine-containing compound, filler (e.g. inorganic fine particles or organic fine particles), silane coupling agent, slip agent (silicone compound such as dimethyl silicone) and surfactant. Particularly preferably the layer contains inorganic fine particles, silane coupling agent and slip agent.

As inorganic fine particles, fine particles of silicon dioxide (silica) or fluorine-containing fine particles (magnesium fluoride, calcium fluoride or barium fluoride fine particles) are preferably used. Particularly preferable are fine particles of silicon dioxide (silica). Preferably the weight average particle size of the primary particles of the inorganic fine particles is 1 to 150 nm, more preferably 1 to 100 nm, and most preferably 1 to 80 nm. Preferably the inorganic fine particles are dispersed more finely in the outmost layer of the low-refractive-index layer. The shape of the inorganic fine particles is preferably a rice-grain-like, spherical, cubic, spindle, short-fiber, ring, or indeterminate shape. To decrease the refractive index, preferably the inorganic fine particles are fine particles of hollow silica.

Preferably the refractive index of the hollow silica fine particle is 1.17 to 1.40, more preferably 1.17 to 1.35, and most preferably 1.17 to 1.30. The refractive index herein used does not mean the refractive index of the outer shell silica that constitutes the hollow silica particle, but means that of the entire hollow silica particle. In such hollow silica particles, the void x expressed by the following numerical formula (VIII):

$$\begin{matrix}x = ( 4 π {a}^{3} / 3 ) / ( 4 π {b}^{3} / 3 ) \times 100 \\ = {( a / b )}^{3} \times 100\end{matrix} \qquad ( Numerical formula VIII )$$

where a is the radius of the cavity in the hollow silica particle and b is the radius of the outer shell of the same, is preferably 10 to 60%, more preferably 20 to 60% and most preferably 30 to 60%. If the refractive index of the hollow silica particle is made lower and the void larger, the thickness of the outer shell is decreased, and thus, the strength of the particle is lowered. Thus, from the viewpoint of scratch resistance, the particle having a refractive index as low as less than 1.17 does not hold.

The process for producing hollow silica is described in, for example, Japanese Patent Application Laid-Open No. 2001-233611 and Japanese Patent Application Laid-Open No. 2002-79616.

As a silane coupling agent, a compound expressed by below described general formula A and/or the derivative thereof can be used. Preferred silane coupling agents are silane coupling agents containing a hydroxyl, mercapto, carboxyl, epoxy, alkyl, alkoxysilyl, acyloxy or acylamino group. And particularly preferred silane coupling agents are silane coupling agents containing an epoxy, polymerizable acyloxy ((meth)acryloyl) or polymerizable acylamino (acrylamino or methacrylamino) group. General formula A
(R10)m-Si(X)4-m
wherein R10 represents an optionally substituted alkyl group or an optionally substituted aryl group; X represents a hydroxyl group or a hydrolysable group; and m is an integer of 1 to 3.

Of the compounds expressed by the general formula A, particularly preferable are compounds containing (meth)acryloyl group as a crosslinkable or polymerizable functional group. Specific examples of such compounds include: 3-acryloxypropyltrimethoxysilane and 3-methacryloxypropyltrimethoxysilane.

As a slip agent, dimethyl silicone or a fluorine compound into which a polysiloxane segment has been introduced is preferable.

Preferably the low-refractive-index layer is formed by coating a coating composition in which a fluorine-containing compound, along with any other ingredients, depending on the situation, are dissolved or dispersed; and at the same time or after the coating operation, crosslinking or polymerizing the coating composition with the aid of light irradiation, electron beam irradiation or heating.

To improve the adhesion to the high-refractive-index layer, it is necessary to bond the low-refractive-index layer and the high-refractive-index layer properly. For this purpose, the oxygen concentration during curing of the low-refractive-index layer is preferably 0.3% or lower, more preferably 0.1% or lower, and most preferably 0.05% or lower. The irradiance is preferably 250 mJ/cm² or higher, more preferably 500 mJ/cm² or higher, and most preferably 750 mJ/cm² or higher.

As described above, to prepare an antireflection film having a better antireflection performance, preferably an intermediate-refractive-index layer that has a refractive index between that of the high-refractive-index layer and that of the transparent substrate.

Preferably the intermediate-refractive-index layer is prepared in the manner described above in connection with the high-refractive-index layer of the present invention. And its refractive index can be adjusted by controlling the content of the inorganic fine particles in the film.

The antireflection film may include layers other than those described above, such as adhesive, shielding, slip and antistatic layers. The shielding layer is for shielding electromagnetic waves or infrared rays.

When the antireflection film is applied to liquid crystal displays, in order to improve the viewing angle characteristics of such displays, an under coat layer to which particles of 0.1 to 10 μm in average particle size have been added can be newly constructed or a light scattering hard coat layer can be formed by adding the particles as described above to the hard coat layer. Preferably the average particle size of the particles added is 0.2 to 5.0 μm, more preferably 0.3 to 4.0 μm, and particularly preferably 0.5 to 3.5 μm.

Preferably the refractive index of the particles is 1.35 to 1.80, more preferably 1.40 to 1.75, and much more preferably 1.45 to 1.75. Preferably the particles have the narrowest particle distribution possible.

Preferably the difference between the refractive index of the particles added to the under coat layer or light scattering hard coat layer and that of the portion of the antireflection film other than the particles is 0.02 or larger, more preferably 0.03 to 0.5, much more preferably 0.05 to 0.4, and particularly preferably 0.07 to 0.3.

As particles added to the under coat layer, various kinds of inorganic or organic particles having a refractive index that falls in the above describe range can be used.

Preferably the under coat layer is constructed between the hard coat layer and the transparent substrate. The under coat layer can also serve as a hard coat layer.

When particles of 0.1 to 10 μm in average particle size are added to the under coat layer, preferably the haze of the under coat layer is 3 to 60%, more preferably 5 to 50%, much more preferably 7 to 45%, and particularly preferably 10 to 40%.

Each layer of the antireflection film can be formed by any one of coating methods such as wire bar coating, reverse gravure coating, forward gravure coating and die coating, as already mentioned. From the viewpoint of minimizing the wet coating amount to avoid unevenness by drying or from the viewpoint of film thickness uniformity across the width of the film and film thickness uniformity across the length of the film during the course of the coating operation, reverse gravure coating and die coating methods are particularly preferable.

From the viewpoint of production cost, it is preferable to form at least 2 layers of a plurality of optical thin films of the antireflection film of the present invention in one process consisting of: delivery of a substrate film; formation of each optical thin film; and wind-up of the resultant film. When the antireflection layer is made up of 3 layers, preferably all the 3 layers are formed in one process. The process for producing an antireflection film as above can be realized by providing in tandem more than one set of coating station, drying zone and curing zone, preferably the same number of sets as the number of optical thin films, between the machine from which a substrate film is delivered and the machine in which the resultant film is wound up.

The optical film production line 10 shown in FIG. 1 illustrates such a construction in a simplified manner.

To use the antireflection film as the surface protective film of a polarization film (protective film for a sheet of polarizer), it is necessary, when forming a sheet of polarizer in accordance with the present invention, to improve the adhesion of the antireflection film to the polarization film, whose chief ingredient is polyvinyl alcohol, by hydrophilizing the one side surface of the transparent substrate opposite to the surface on which the high-refractive-index layer is provided, that is, the surface of the transparent substrate on which the polarization film is stacked.

As a transparent substrate, preferably a triacetyl cellulose film is used.

There are two possible methods for preparing a protective film for a sheet of polarizer: (1) a method in which layers as described above (e.g. high-refractive-index layer, hard coat layer, the outermost layer) are provided by coating on one side of a transparent substrate having been saponified; and (2) a method in which layers as described above (e.g. high-refractive-index layer, hard coat layer, low-refractive-index layer, the outermost layer) are provided by coating on one side of a transparent substrate and saponification is performed for the other side of the transparent substrate on which a polarization film is to be stacked. However, in the method (1), even the surface of the transparent substrate on which a hard coat layer is to be provided is saponified, whereby adhesion between the substrate and the hard coat layer is hard to ensure. Thus, the method (2) is preferable.

In the following saponification will be described.

(1) Immersing Method

This method is to immerse an antireflection film in an alkaline solution under suitable conditions to allow all the alkali-reactive surfaces of the entire film to undergo saponification. It requires no special equipment, and therefore, it is preferable from the viewpoint of cost. Preferably the alkaline solution is sodium hydroxide aqueous solution. Preferably the concentration of the alkaline solution is 0.5 to 3 mol/L and particularly preferably 1 to 2 mol/L. Preferably the temperature of the alkali solution is 30 to 70° C. and particularly preferably 40 to 60° C.

The combination of the above described saponification conditions is preferably that of relatively moderate conditions, and such combination can be set depending on the material or construction of the antireflection film or the contact angle aimed at.

After immersed in an alkaline solution, the antireflection film is fully washed with water or immersed in a dilute acid to neutralize the alkaline component so that no alkaline component remains in the film.

Saponification hydrophilizes the one side surface of the transparent substrate opposite to the surface on which the antireflection layer is provided. The protective film for a sheet of polarizer is used in such a manner that the hydrophilized surface of the transparent substrate is adhered to a polarization film.

The hydrophilized surface is effective in improving the adhesion to the adhesive layer that contains polyvinyl alcohol as a chief ingredient.

From the viewpoint of adhesion to the polarization film, it is preferable to perform saponification so that the one side surface of the transparent substrate opposite to the surface on which the high-refractive-index layer is provided has the smallest water contact angle possible. However, in the immersing method, the surface on which the high-refractive-index layer is provided is also exposed to saponification, and hence damaged by alkali; thus, it is important to perform saponification under the least necessary conditions. When using, as an index of damage to the antireflection film by alkali, the water contact angle of the one side surface of the transparent substrate opposite to the surface on which the antireflection-structure layer is provided, in other words, the water contact angle of the surface of the antireflection film to which the polarization film is bonded, if the substrate is a triacetyl cellulose film, the water contact angle is 20 to 50 degrees, preferably 30 to 50 degrees, and more preferably 40 to 50 degrees. The water contact angle of 50 degrees or larger presents the problem of adhesion to the polarization film, and hence it is not preferable, while if the water contact angle is smaller than 20 degrees, the antireflection film is so badly damaged that the physical strength and resistance to light of the resultant film deteriorate, and hence it is not preferable.

(2) Alkaline Solution Coating Method

As a device which avoids the damage to the antireflection film caused in the above described immersing method, an alkaline solution coating method is preferably used which includes the steps of: applying an alkaline solution, under proper conditions, only to the one side surface of the transparent substrate opposite to the surface on which an antireflection film is provided; heating the surface having the alkaline solution applied; washing the same with water; followed by drying. The term “coating” herein used means bringing an alkaline solution etc. into contact only with the surface as an object of saponification. Preferably such saponification is performed so that the surface of the antireflection film to which the polarization film is bonded has a water contact angle of 10 to 50 degrees. This alkaline solution coating method may also be performed by bringing an alkaline solution into contact with the surface, as an object of saponification, by spraying or bringing the surface, as an object of saponification, into contact with a belt or the like which contains an alkaline solution. Employing this method requires additional equipment and steps for applying an alkaline solution, and thus, it is inferior to the immersing method (1) in terms of cost. But on the other hand, since an alkaline solution is brought into contact only with the surface as an object of saponification, it is possible to provide layers formed of materials weak to such an alkaline solution on the opposite side surface. For example, it is not desirable to provide a deposited film or sol-gel film on the opposite side surface, because they are affected by an alkaline solution, specifically they are corroded by, dissolved in, or peeled off by an alkaline solution, but employing this coating method makes it possible to provide a deposited film or sol-gel film on the opposite side surface.

In both of the methods (1) and (2), saponification can be performed for a substrate in roll, after forming the layers described above on the wound-off substrate. Thus, the saponification step may be included in a sequence of antireflection film production operations, as an additional step to the steps of forming the above layers. Further, if a step of bonding of a polarization film, which is also formed of a substrate in roll by applying layers on the wound-off substrate, is performed in a sequence of operations, sheets of polarizer can be prepared more effectively than when a step of bonding of a polarization film is performed for the substrate in sheet form.

A preferred sheet of polarizer includes an antireflection film of the present invention as at least one protective film of the polarization film (protective film for a sheet of polarizer), as shown in FIG. 5. In FIG. 5, the transparent substrate (1) of the antireflection film is bonded to the polarization film (7) via the adhesive layer (6) composed of polyvinyl alcohol, while the other protective film (8) of the polarization film is bonded to one principal surface opposite to the other principal surface to which the antireflection film of the polarization film (7) is bonded via the adhesive layer (6). The sheet of polarizer includes a pressure-sensitive adhesive layer (9) on one principal surface of the protective film (8) opposite to the other principal surface to which the polarization film is bonded.

Using the antireflection film of the present invention as a protective film for a sheet of polarizer makes it possible to produce a sheet of polarizer having the antireflection function, along with excellent physical strength and resistance to light, which in turn makes it possible to reduce production costs significantly and provide thinner displays.

If a sheet of polarizer is formed in which an antireflection film of the present invention is used for one protective film for a sheet of polarizer and an optically isotropic optical compensation film is used for the other protective film of the polarization film, the contrast of liquid crystal displays in light rooms can be improved and the viewing angle of the same in both vertical and lateral directions can be widened.

An optical compensation film (retardation film) can improve the viewing angle characteristics of liquid crystal display screens.

As an optical compensation film, any known one can be used; however, from the viewpoint of realizing a wider viewing angle, the optical compensation film described in Japanese Patent Application Laid-Open No. 2001-100042 is preferable which includes an optically isotropic layer composed of a compound having a discotic structural unit and is characterized in that the angle between the discotic compound and the transparent substrate varies with the distance from the substrate.

Preferably the above angle increases with the increase in distance from the optically anisotropic layer on the substrate surface side.

When using an optical compensation film as a protective film, preferably the surface of the film to which a polarization film is bonded undergoes saponification. And preferably the saponification is performed in accordance with the above described saponification procedure.

The optical compensation films are also preferable in which the optical compensation layer further includes cellulose ester; in which an oriented layer is formed between the optically anisotropic layer and the transparent substrate; and in which the transparent substrate of the optical compensation film having the optically anisotropic layer is negative uniaxial, has an optical axis in the direction normal to the transparent substrate surface, and satisfies the following requirement.
20≦{(nx+ny)/2−nz}×d≦400
In the above expression, nx represents the refractive index of the film in the in-plane slow axis direction (in such a direction that the refractive index is the maximum), ny the refractive index in the in-plane fast axis direction (in such a direction that the refractive index is the minimum); nz the refractive index across the thickness of the film; and d the thickness of the optical compensation layer.

The sheet of polarizer including the antireflection film is applicable to display systems such as liquid crystal displays (LCDs) and electroluminescence displays (ELDs).

When used in a liquid crystal display, the sheet of polarizer including the antireflection film of the present invention as shown in FIG. 5 is bonded directly or via some other layer to the glass of liquid crystal cells of the liquid crystal display.

The sheet of polarizer including the antireflection film is preferably used in twisted nematic (TN), super twisted nematic (STN), vertical alignment (VA), in-plane switching (IPS) or optically compensated bend cell (OCB) mode transmissive, reflective or semi-transmissive liquid crystal displays.

When the sheet of polarizer is used in transmissive or semi-transmissive liquid crystal displays, if a commercially available brightness enhanced film (polarized light separation film including a polarized light selecting layer, e.g. D-BEF, manufactured by Sumitomo 3M Limited) is used together, liquid crystal displays having higher visibility can be obtained.

Further, the combination of the sheet of polarizer with a λ/4 plate can be used as a sheet of polarizer for reflective liquid crystal displays or a protective sheet for organic EL displays so that reflected light from the surface and the inside is decreased.

In the following a process for producing an optical film which uses the optical film production line shown in FIG. 1 will be described. First, a web W 40 to 300 μm thick, which is a transparent substrate having a polymer layer formed on its surface, is delivered from delivery machine 66. The web W is guided by guide rollers 68 to be fed into dust removal equipment 74, where the dust deposited on the surface of the web W is removed. Then, a coating solution is applied to the web W by the coating head 12 of the extrusion coating equipment.

After completion of coating, the web is passed through the drying zone 76 and the heating zone 78 so that a coating film is formed on the web. Then the coating film is exposed to ultraviolet ray with ultraviolet ray irradiation equipment 80 to crosslink the liquid crystal, thereby forming a desired polymer. The web W having a polymer formed on its surface is wound up by the wind-up machine 82.

According to the construction of this embodiment, the slot width d of the slot die 20 is 250 μm or smaller and the ratio of the slot length L to the slot width d, L/d, is 300 or higher, whereby pulsation of coating solution during its feeding can be effectively controlled, and hence step unevenness.

Although the coating method, coating equipment, process for producing an optical film and process for producing an antireflection film of the present invention have been described in terms of their embodiments, it is to be understood that the present invention is not limited to the specific embodiments thereof, but may be otherwise variously embodied within the sprit and scope of the invention.

In one embodiment a production of an optical film (optically functional film), in particular, that of an antireflection film has been described; however, the present invention is not limited to the embodiment, but applicable to coating in general.

The present invention produces a remarkable effect in the application of a small amount of coating solution; however, it is not limited to this specific example, but applicable to various kinds of coating solutions.

The shape of the coating head 12 of the extrusion coating equipment is not limited to the present embodiment, either, but may be otherwise variously embodied. For example, the cross sections of the front edge surface 30a and the back edge surface 32a can take any other form such as an arc or parabola.

A coating head can also be employed which is so constructed that unevenness is provided between the rear edge of the front edge surface 30a and the leading edge of the back edge surface 32a, in other words, the rear edge of the front edge surface 30a and the leading edge of the back edge surface 32a form a so-called overbite shape, whereby a film of the coating solution F having prescribed thickness can be formed.

### EXAMPLES

Examples 1 to 3 will be described below.

### Example 1

As a web W, a polyethylene terephthalate (PET) film 1000 mm wide (manufactured by Toray Industries, trade name: Lumilar) was used. The web W conveying speed was 20 m/min.

As a coating solution F, a coating solution for a low-refractive index layer was used. The coating solution for a low-refractive index layer had a refractive index of 1.42 and was prepared by: adding 8 g of MEK-ST (dispersion of SiO₂ sol having an average particle size of 10 nm to 20 nm and a solid concentration of 30% by weight in methyl ethyl ketone, manufactured by NISSAN CHEMICAL INDUSTRIES, LTD.), 94 g of methyl ethyl ketone and 6 g of cyclohexanone to 93 g of solution of 6% by weight fluorine-containing thermosetting polymer in methyl ethyl ketone (manufactured by JSR Corporation, model number: JN-7228); stirring the solution mixture; followed by filtration through a polypropylene filter having a pore diameter of 1 μm (PPE-01). Four different types of coating solutions F having a viscosity of 1, 5, 15 and 20 mPas, respectively, were prepared.

The wet film thickness of the coating solution F was 10 μm. A vacuum chamber 40 was used.

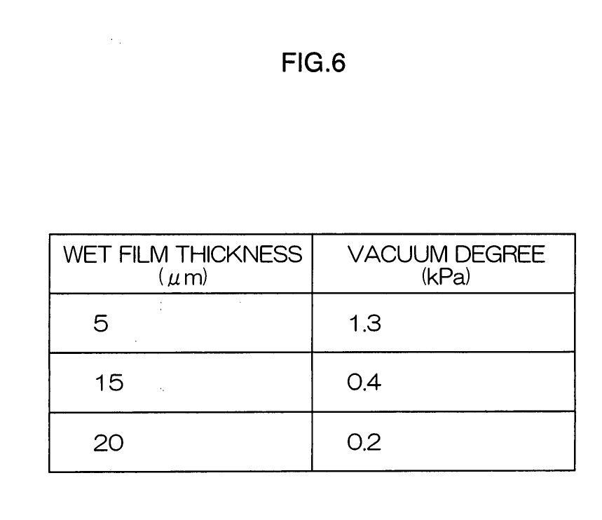

The front edge surface 30a (front end lip) of the coating head 12 shown in FIG. 3 was formed so that its land length was 1000 μm, while the back edge surface 32a (rear end lip) of the same was formed so that its land length was 50 μm. The slot width (slot clearance) d of the slot 20 was varied to four different levels between 100 and 500 μm and the slot length L of the slot 20 was varied to 3 different levels between 30 and 90 mm. The clearance (lip clearance) between the front edge surface 30a (front end lip) of the coating head 12 and the surface of the web W was adjusted to 50 μm. The vacuum degree of the vacuum chamber 40 under these conditions was as shown in FIG. 6.

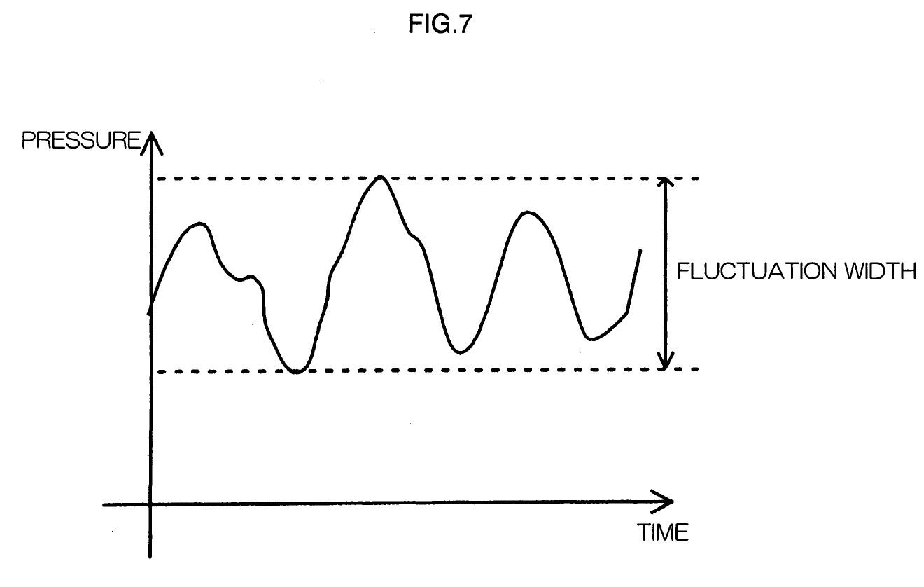

The fluctuations in the pressure inside the fluid reservoir 18 of the coating head 12 were measured under the above conditions. As a measuring instrument, pressure transducer (manufactured by COSMO INSTRUMENTS CO., LTD., model number: PT-162A) was used. The calculations of the fluctuation width using the difference between the maximum and the minimum of the measurements are as shown by the graph in FIG. 7. In the graph, elapsed time is plotted in abscissa and the measured pressure in ordinate. The fluctuation width was 7.0 Pa in each under any of the above conditions.

Step unevenness failure was evaluated which occurred when each coating solution for a low-refractive-index layer was applied to the web W.

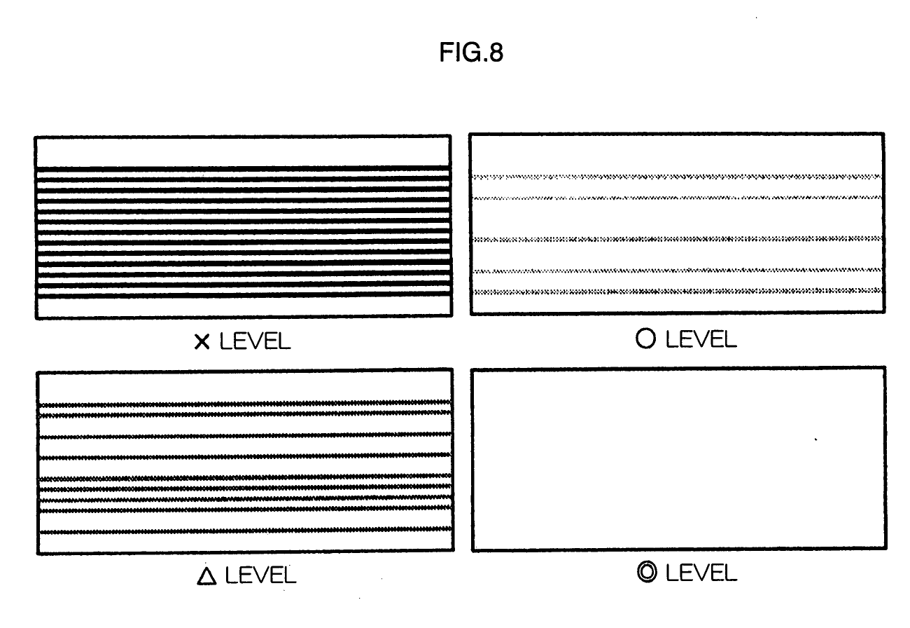

The step unevenness failure in each case was evaluated and graded according to four ranks. Specifically, the coating film at such a level that no step unevenness was visually observed was graded very good, the coating film at such a level that a few defects were observed, but they were no problem was graded good, the coating film in part of which step unevenness occurred was graded poor, and the coating film on the entire surface of which step unevenness occurred was graded very poor. The states of the four different levels are shown in FIG. 8.

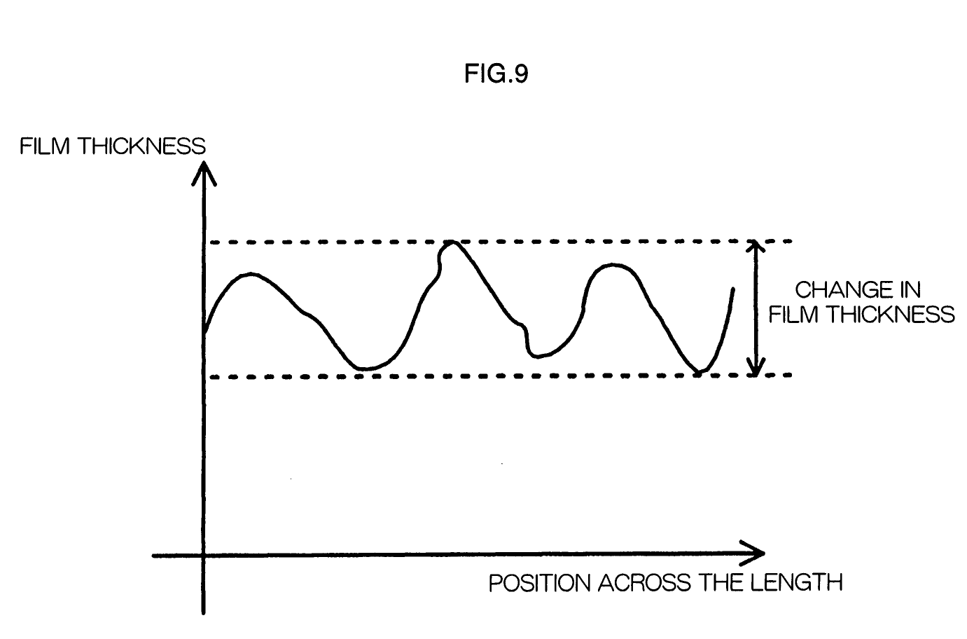

Further, the thickness of the failure portion was measured using optical interference film thickness gauge (manufactured by OTSUKA ELECTRONICS CO., LTD., model number: FE-3000) and the change in film thickness at step unevenness portions was obtained. And the rate of change in film thickness relative to the average film thickness was calculated. The results are as shown by the graph in FIG. 9. In the graph, position across the length of the web W is plotted in abscissa and the average film thickness in ordinate.

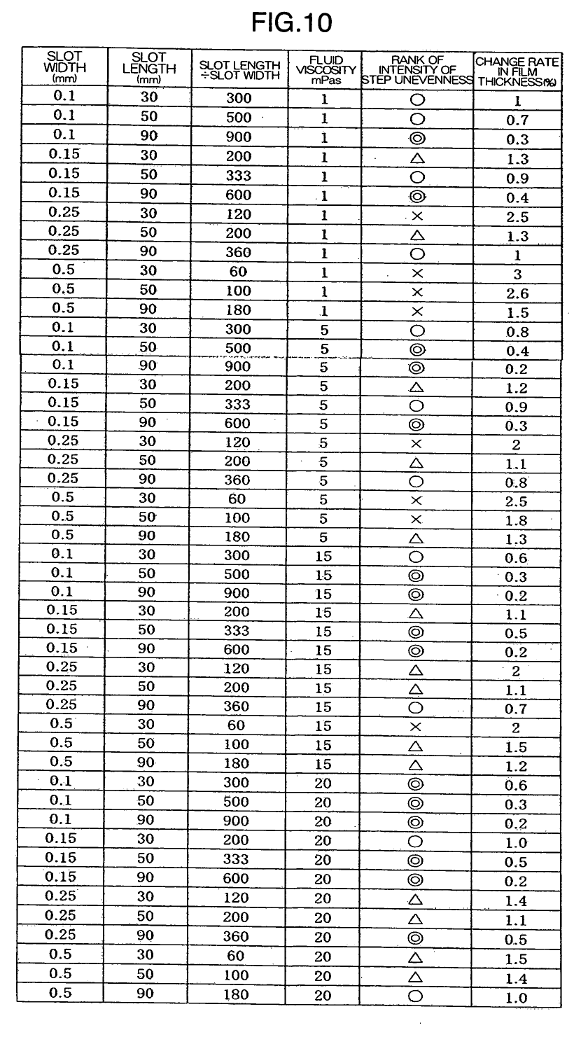

The conditions under which coating films were formed and the evaluations for the resultant coating films are summarized in the table of FIG. 10.

The results shown in FIG. 10 confirmed that when the slot width (slot clearance) d was 250 μm or smaller and the ratio of the slot length L to the slot width d, L/d, was 300 or higher, step unevenness caused by the pulsation of the coating solution delivered could be reduced to such a level as was no problem and the fluctuation in film thickness due to the step unevenness was narrowed.

When the viscosity of the coating solution was adjusted to 20 mPas, step unevenness was hard to occur due to the pulsation retarding effect of the high-viscosity coating solution, whereby even if the conditions were outside the range of the present invention, step unevenness was not a problem under certain conditions.

### Example 2

A like experiment was conducted under almost the same conditions as in Example 1 varying the pressure inside the fluid reservoir 18. As a coating solution F, the same coating solution as that of Example 1 whose viscosity was adjusted to 1 mPas was used.

Like Example 1, the front edge surface 30a (front end lip) of the coating head 12 shown in FIG. 3 was formed so that its land length was 1000 μm, while the back edge surface 32a (rear end lip) of the same was formed so that its land length was 50 μm.

The slot width (slot clearance) d of the slot 20 was varied to four different levels between 100 and 500 μm and the slot length L of the slot 20 was varied to 3 different levels between 30 and 90 mm. The clearance (lip clearance) between the front edge surface 30a (front end lip) of the coating head 12 and the surface of the web W was adjusted to 50 μm. The fluctuation width in the pressure inside the fluid reservoir 18 was varied to two different levels, 10 Pa and 15 Pa.

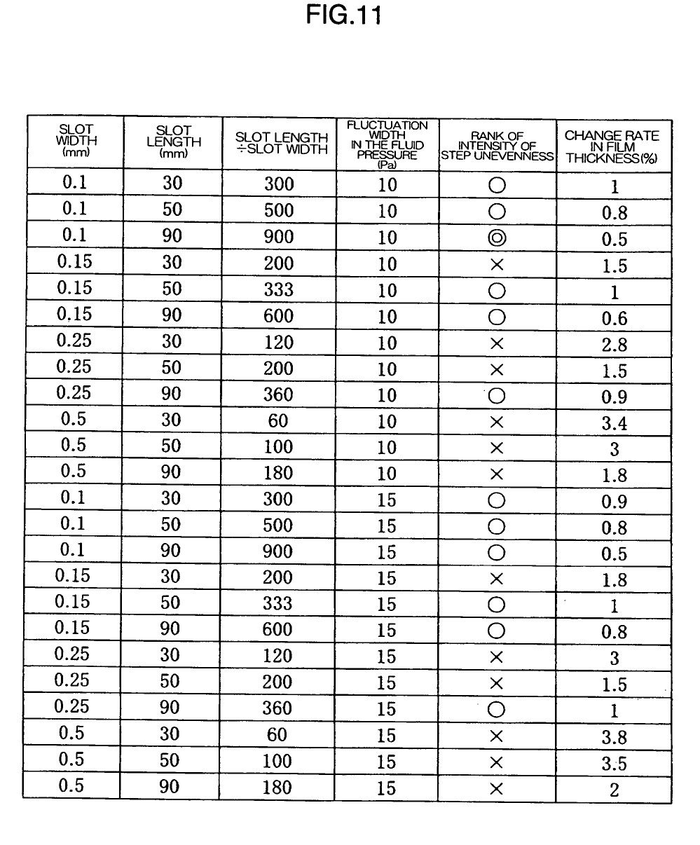

The conditions under which coating films were formed and the evaluations for the resultant coating films are summarized in the table of FIG. 11. The table of FIG. 11 confirmed that the present invention was effective irrespective of the fluctuation width.

### Example 3

An antiglare and antireflection sheet was prepared. As a base, an 80-μm-thick three-layer triacetyl cellulose film formed by co-casting was used. In this film, there was observed no clear interface.

(Preparation of Coating Solution for Antiglare Layer)

A coating solution for antiglare layer was prepared by dissolving 75 g of mixture of dipentaerythritol pentacrylate and dipentaerythritol hexaacrylate (DPHA, manufactured by NIPPON KAYAKU CO., LTD.) and 240 g of hard coat coating solution containing a dispersion of zirconium oxide ultra fine particles about 30 nm in particle size (Desolite Z-7401, manufactured by JSR Corporation) in 52 g of mixed solvent of methyl ethyl ketone/cyclohexanone=54/46% by weight.

To the resultant coating solution, 10 g of photo initiator (Irugacure 907, manufactured by Ciba Fine Chemical) was added and stirred until the photo initiator was dissolved in the fluid. Then, 0.93 g of fluorine surfactant made up of a solution of 20% by weight fluorine-containing oligomer in methyl ethyl ketone (egafac F-176 PF, manufactured by DAINIPPON INK AND CHEMICALS, INC.) was added to the fluid. (The refractive index of the coating film obtained by UV curing this solution was 1.65.)

To the resultant fluid was added 29 g of dispersion which was obtained by: dispersing 20 g of crosslinked polystyrene particles having a number average particle size of 2.0 μm and a refractive index of 1.61 (SX-200HS, manufactured by Soken Chemical & Engineering Co., Ltd.) in 80 g of mixed solvent of methyl ethyl ketone/cyclohexanone=54/46% by weight with stirring with high-speed disperser at 5000 rpm for 1 hour; and filtering the dispersion through polypropylene filters having a pore diameter of 10 μm, 3 μm and 1 μm, respectively (PPE-10, PPE-03, PPE-01, respectively, manufactured by Fuji Photo Film Co., Ltd.), and the mixture was stirred and filtered through a polypropylene filter having a pore diameter of 30 μm to prepare a coating solution for antiglare layer.

(Preparation of Coating Solution for Low-Refractive-Index Layer)

A coating solution for low-refractive index layer having a refractive index of 1.42 was prepared by: adding 8 g of MEK-ST (dispersion of SiO₂ sol having an average particle size of 10 nm to 20 nm and a solid concentration of 30% by weight in methyl ethyl ketone, manufactured by NISSAN CHEMICAL INDUSTRIES, LTD.), 94 g of methyl ethyl ketone and 6 g of cyclohexanone to 93 g of solution of 6% by weight fluorine-containing thermosetting polymer in methyl ethyl ketone (manufactured by JSR Corporation, model number: JN-7228); stirring the solution mixture; followed by filtration through a polypropylene filter having a pore diameter of 1 μm (PPE-01). The viscosity of the coating solution was 1.0 mPas.

An antiglare layer 1.5 μm thick was prepared by: applying the foregoing coating solution for antiglare layer to the foregoing base using the coating method of the present invention; drying the fluid at 120° C.; and exposing the dried fluid to ultraviolet ray at an irradiance of 400 mW/cm² and a dose of 300 mJ/cm² using a 160 W/cm air-cooled metal halide lamp (manufactured by Eyegraphics Co., Ltd.) to cure the same.

The foregoing coating solution for low-refractive index layer was applied to the resultant antiglare layer using the coating method of the present invention, dried at 80° C., and heat crosslinked at 120° C. for 8 minutes to form a low-refractive-index layer 0.096 μm thick. Thus, an antiglare and antireflection sheet was obtained. The coating conditions were such that the slot width (slot clearance) d of the slot 20 was 150 μm, the slot length L of the slot 20 60 mm, the coating speed 20 m/min and the wet film thickness 5 μm.

The antiglare and antireflection sheet was made to reflect non-louvered naked fluorescent light (8000 cd/m²), and the degree of the blur of the reflection image was observed. However, no step unevenness failure was observed and it was found that the coating film had so excellent optical properties that the outline of the fluorescent light was never recognized. The measurement of the film thickness across the width of the film showed that the coating amount distribution was as very good as ±1.5%.

What is claimed is:

1. A method for coating, comprising the step of:
coating with a coating solution using a slot die the surface of a substrate which is continuously running while being supported by a back-up roller, wherein the slot width d of the slot die is 250 μm or less and the ratio of the slot length L to the slot width d, L/d, is 300 or more.

2. The coating method according to claim 1, wherein the viscosity of the coating solution is 15×10⁻³ Pa·s or lower.

3. The coating method according to claim 1, wherein a coating film is formed so that the wet film thickness of the coating solution is 15 μm or smaller.

4. The coating method according to claim 2, wherein a coating film is formed so that the wet film thickness of the coating solution is 15 μm or smaller.

5. A process for producing an optical film, comprising forming a coating layer using a coating method of claim 1.

6. A process for producing an optical film, comprising forming a coating layer using a coating method of claim 2.

7. A process for producing an optical film, comprising forming a coating layer using a coating method of claim 3.

8. A process for producing an optical film, comprising forming a coating layer using a coating method of claim 4.

9. A process for producing an antireflection film, comprising forming a coating layer having the antireflection function using a coating method of claim 1.

10. A process for producing an antireflection film, comprising forming a coating layer having the antireflection function using a coating method of claim 2.

11. A process for producing an antireflection film, comprising forming a coating layer having the antireflection function using a coating method of claim 3.

12. A process for producing an antireflection film, comprising forming a coating layer having the antireflection function using a coating method of claim 4.

13. Equipment for coating with a coating solution the surface of a substrate which is continuously running, comprising:
a back-up roller supporting the substrate, and
a slot die by which the coating solution is coated,
wherein the slot width d of the slot die is 250 μm or less and the ratio of the slot length L to the slot width d, L/d, is 300 or more.
